(19) United States
(12) Patent Application Publication
(10) Pub. No.: US 2005/0269418 A1
(43) Pub. Date: Dec. 8, 2005

(54) Monitoring system

(76) Inventor: Andrew Corbin Fuller, Ridgeville, SC (US)

Correspondence Address: John B. Hardaway,III;NEXSEN PRUET, LLC, P.O. Box 10107, Greenville, SC, 29603, US

(21) Appl. No.: 11/202,860

(22) Filed: Aug. 12, 2005

Related U.S. Application Data
(63) Continuation-in-part of application No. 10/692,475, filed on Oct. 24, 2003.

(51) Int. Cl. B01F 3/02; G05D 21/00; F25D 17/06

(52) U.S. Cl. 236/44 A; 236/44 R

(57) ABSTRACT

A monitoring system for maintaining an optimal environment within interior spaces, including a dehumidification system including a controller having a humidity sensor switch that turns the dehumidifier, as well as the plurality of fans, on and off based on the ambient humidity of the area in which the dehumidification system is placed. Additionally, the dehumidification system includes a user interface unit that is separate from the dehumidifier, and that can be used to operate the dehumidification system from remote locations.

### CROSS REFERENCE TO RELATED APPLICATIONS

The present application claims the benefit of the priority filing date of U.S. application Ser. No. 10/692,475, filed on Oct. 24, 2003, and U.S. Application Ser. No. 60/558,726, filed on Apr. 1, 2004.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

The present invention relates to monitoring systems for interior spaces, and, in particular, to a monitoring system that can regulate the ambient humidity and temperature of interior and enclosed spaces so as to protect these spaces from damage by the environment within these spaces.

Depending on the particular building materials used in the surrounding walls of interior spaces, and depending on the potential for exposure to moisture of these spaces, practically any enclosed space can be susceptible to damage. An area very susceptible to damage caused by moisture, such as mildew and termite damage is the basement or crawl space of a house. Therefore, the ability for homeowners to maintain reduced moisture levels in the basement can be critical to preserve the structural integrity of the house, as well as to preserve the environment within the basement of the house.

Another area that is susceptible to moisture damage is the interior space of boats. In particular, the engine rooms and the interior cabins of boats that are stored at marinas can easily become mildewed, giving the boats a musty odor and damaging the materials of the boats.

Appliances for removing moisture from enclosures or interior spaces are known to prevent these areas from becoming damaged. For example, dehumidifiers are well known for use in removing moisture from the atmosphere. However, typical dehumidifiers require that a user operate the dehumidifier at the location of the unit itself. Further, the controller systems of dehumidifiers are such that the unit is either constantly running or constantly turned off. Therefore, if the user is not diligent in turning the unit on and off based on need, there is a risk that either energy will be wasted or that mildew and moisture damage will persist.

Accordingly, there exists a need for an effective and convenient system for use in monitoring and protecting areas that are susceptible to moisture damage.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

According to its major aspects and briefly stated, the present invention is a monitoring system for use in controlling the temperature and humidity within confined spaces and thereby protecting these spaces from potential moisture damage. The present invention has industrial utility in that the interior environment of commercial facilities may be optimally maintained and monitored.

In a first embodiment, the monitoring system includes a sensor for determining the humidity, moisture, and/or temperature of an area, means for communicating the humidity, moisture, and/or temperature to a controller that is interconnected with the sensor, means for warning when the humidity, moisture, and/or temperature within the area is above a preset, desired humidity, moisture, and/or temperature, and means for adjusting the humidity, moisture, and/or temperature to approximately equal to or below the preset, desired humidity, moisture, and/or temperature. Although various alternative means can be employed to adjust the humidity, moisture, and/or temperature to a desired level, the present invention can include a dehumidification system as the adjusting means. This adjusting system can include a dehumidifier that is connected to the sensor and a second controller having a sensor switch that turns the dehumidifier on and off based on the ambient humidity, moisture, and/or temperature of the area in which the monitoring system is placed. Additionally, the monitoring system can include a user interface unit that is separate or remote from the dehumidifier, and that can be used to operate the monitoring system from remote locations. The user interface can include a number of inputs, as well as a service light, which indicates a need for maintenance or repair. The dehumidifier can also be connected to a plurality of fans. In larger enclosed areas, the use of multiple fans can facilitate the adjustment of humidity, moisture, and/or temperature. Furthermore, it is contemplated by the present invention that the features of the monitoring system can either be operated through standard electrical connections or through wireless connections.

In a second embodiment, the second controller of the dehumidification system can include a humidity switch and a building materials moisture indicator switch. The building materials moisture switch works in combination with the humidity switch so that the dehumidifier is turned on or off either by the moisture switch or the humidity switch depending on moisture content and ambient humidity. The building material moisture and ambient humidity can be transmitted to the second controller by the sensor of the monitoring system either through electrical, radio frequency, or wireless transmission.

In a third embodiment, the adjusting means of the monitoring system includes a combination system having a ventilation portion and a dehumidification portion. The ventilation portion can include the combination system is described in detail in U.S. Pat. Nos. 4,208,010 and 4,328,927, which are incorporated herein by reference. The only modification to this ventilation portion is that the louvers of the ventilator structure operate so that the louvers are open during cold weather and the louvers are closed during warm weather. Alternatively, the ventilation portion can include a ventilation device such as described in U.S. Pat. No. 5,944,445, which is incorporated herein by reference. The only modification to this ventilation device would be that the vent would be closed at temperatures below about 40° F. and above about 60° F. The dehumidification portion can include similar features to those described in the alternative embodiments.

In a fourth embodiment, the monitoring system includes sensors for determining the humidity, moisture content, and temperature of an area, means for communicating the humidity, moisture content, and temperature to a controller that is interconnected with the sensors, means for warning when the humidity, moisture content, and temperature within the area is above a preset, desired humidity, moisture content, and temperature, and means for adjusting the humidity, moisture content, and temperature to approximately equal to or below the preset, desired humidity, moisture, and temperature. Although various alternative means can be employed to adjust the humidity, moisture content, and temperature to a desired level, the present invention can include an ambient adjustment system as the adjusting means. This ambient adjustment system can include a dehumidifier and an hvac unit that are both connected to the sensors and a second controller, which includes a first sensor switch that turns the dehumidifier on and off based on the ambient humidity and moisture content, and a second sensor switch that turns the hvac on and off based on the temperature of the area in which the monitoring system is placed. Additionally, the monitoring system can include a user interface unit that is separate or remote from the ambient adjustment system, and that can be used to operate the monitoring system from remote locations. The user interface can include a number of inputs, as well as a service light, which indicates a need for maintenance or repair. The ambient adjustment system can also be connected to a plurality of fans. In larger enclosed areas, the use of multiple fans can facilitate the adjustment of humidity, moisture content, and temperature. Additionally, the ambient adjustment system can further be connected to a vent system, wherein a plurality of vents can open and close based on ambient temperature. Further, the ambient adjustment system can be connected to the main water valve of a building so that the water can be shut off and on depending on the moisture content of the building. It is further contemplated by the present invention that the features of the monitoring system can either be operated through standard electrical connections or through wireless connections.

A feature of the present invention is the use of a monitoring system including means for adjusting humidity, moisture, and/or temperature that includes a dehumidification system in interior or enclosed spaces such as the crawl space of a house and the engine room of a boat. Not only will the use of a dehumidifier in these areas reduce and prevent the musty odor caused by potential mildew, but also the materials used to construct houses and boats can be better preserved. Further, keeping these areas dry prevents the growth of pests that can be damaging to the area, such as termites.

Another feature of the present invention is the use of a monitoring system including means for adjusting humidity, moisture, and/or temperature that includes a user interface unit in combination with a dehumidifier. Typically, dehumidifiers must be operated at the location of the unit itself. Because areas such as the basement or crawl space of a house tend to be small and unfinished, placing a unit in these areas can be unpleasant and burdensome on the user of the unit who is forced to constantly enter the basement to operate the unit. A user interface can avoid the need for entering these areas, so that a user can operate the dehumidifier in comfortable and convenient locations within the house.

Yet another feature of the present invention is the use of a monitoring system including means for adjusting humidity, moisture, and/or temperature that includes a dehumidifier in combination with a plurality of fans. Dehumidifiers tend to include fans within the unit so that moist air is circulated into the unit and dry air is circulated out of the unit. However, if the enclosed area to be dehumidified is relatively large, the dehumidifier may take a long time to dry the air. Through the use of a plurality of fans positioned in various locations around the dehumidifier, the moist air can be more effectively dried. Further, the fans contribute to the improvement of the environment of the interior space by circulating dried and fresh air.

Still another feature of the present invention is the use of a monitoring system including means for adjusting humidity, moisture, and/or temperature that includes a second controller that is connected to a sensor and a sensor switch, wherein the adjusting means is activated or deactivated based on a preset, desired humidity, moisture, and/or temperature level. For example, if the ambient humidity is higher than the desired humidity, the adjusting means will be activated, and if the ambient humidity is below the desired humidity, the adjusting means will be deactivated. The sensor switch allows the monitoring system to remain energy and cost efficient.

The use of a monitoring system including a dehumidification system having a second controller having both a humidity switch and a building material moisture indicator switch is yet another feature of the present invention. By using a combination of switches, the dehumidification system can effectively eliminate and prevent moisture damage of the interior spaces. If the moisture contact is too high in the building material of the interior space, the dehumidifier is started. However, if only the moisture content of the air is too high, rather than the building material, then the dehumidifier is still turned on.

Yet another feature of the present invention is the use of a monitoring system including a dehumidification system having a user interface including a service light. The service light alerts the user that the dehumidification system is in need of either maintenance or repair. Therefore, the lifespan of the dehumidifier can be prolonged, and its function enhanced.

Still another feature of the present invention is the use of a monitoring system that negates the need to seal those interior spaces that are to be monitored for potential damage due to moisture. It is known that spaces, such as the basements and crawl spaces of houses, can contain levels of harmful gases, such as radon. If these spaced are completely enclosed for the sake of keeping out moisture, such gases can build up and create dangerous, harmful environments to the inhabitants of the house. The present system contributes to the circulation of fresh air throughout the space.

Yet another feature of the present invention is the use a monitoring system including means for warning when the humidity, moisture, and/or temperature within the area is the preset, desired humidity, moisture, and/or temperature in combination with means for adjusting the humidity, moisture, and/or temperature to approximately equal to or below the preset, desired humidity, temperature and moisture. This feature enables the constant monitoring of an area that is susceptible to moisture damage so as to prevent such damage. Similar to a burglar alarm system, the present invention can monitor an area from a remote location and either activate a means for adjusting the area in danger of the damage, or, alternatively, communicate the danger to a repair person who is dispatched to the area for attention to such area.

Another feature of the present invention includes the use of an ambient adjustment system including a dehumidifier and an hvac unit. In combination with the monitoring system, this feature allows the constant and complete monitoring and optimization of interior space conditions. Not only can potential damage to interior spaces by excess moisture or humidity be avoided, but also, the temperature within these spaces can be kept at an ideal level to further prevent the formation of excess humidity and moisture.

Still another feature of the present invention is the use of a monitoring system that is connected to the main water valve of a building. In the case that the monitoring system detects alarmingly high moisture content, the water valve can be shut off to prevent potential flooding to the interior space of the building.

Other features and advantages of the present invention will be apparent to those skilled in the art from a careful reading of the Detailed Description of the Preferred Embodiments presented below and accompanied by the drawings.

### BRIEF DESCRIPTION OF THE DRAWINGS

In the drawings,

FIG. 1 is a schematic view of a monitoring system according to an embodiment of the present invention;

FIG. 2 is a cross-sectional side view of a house containing an adjusting means of a monitoring system according to an alternative embodiment of the present invention;

FIG. 3 is a top view of the crawl space of a house containing a monitoring system including an adjusting means according to an alternative embodiment of the present invention;

FIG. 4 is a front view of a user interface unit of an adjusting means of a monitoring system according to an alternative embodiment of the present invention;

FIG. 5 is schematic view of the component parts of an adjusting means of a monitoring system according to an alternative embodiment of the present invention;

FIG. 6 is a cross-sectional side view of a boat containing an adjusting means of a monitoring system according to an alternative embodiment of the present invention;

FIG. 7 is a perspective view of an RV containing an adjusting means of a monitoring system according to an alternative embodiment of the present invention;

FIG. 8 is a cross-sectional side view of a house containing an adjusting means of a monitoring system according to an alternative embodiment of the present invention;

FIG. 9 is an exploded perspective view of a ventilator portion of an adjusting means of a monitoring system according to an alternative embodiment of the present invention;

FIG. 10 is a perspective view of a ventilator portion of an adjusting means of a monitoring system according to an alternative embodiment of the present invention;

FIG. 11 is a schematic view of the components of an ambient adjustment system according to an alternative embodiment of the present invention;

FIG. 12 is a side, partial cut away view of an 18-wheeler truck housing a dehumidification system according to an alternative embodiment of the present invention;

FIG. 13 is a cross-sectional side view of a house containing an ambient adjusting system according to an alternative embodiment of the present invention.

### DETAILED DESCRIPTION OF THE PREFERRED EMBODIMENTS

The present invention includes a monitoring system 1 having a sensor for determining the humidity, moisture, and/or temperature of an area, means for communicating the humidity, moisture, and/or temperature to a first controller that is interconnected with the sensor, means for warning when the humidity, moisture, and/or temperature within the area is above a preset, desired humidity, moisture, and/or temperature, and means for adjusting the humidity, moisture, and/or temperature to approximately equal to or below the preset, desired humidity, moisture, and/or temperature. As discussed, a feature of the present invention includes the use a monitoring system including means for warning when the humidity, moisture, and/or temperature within the area is the preset, desired humidity, moisture, and/or temperature in combination with means for adjusting the humidity, moisture, and/or temperature to approximately equal to or below the preset, desired humidity, temperature and moisture. This feature enables the constant monitoring of an area that is susceptible to moisture damage so as to prevent such damage. Similar to a burglar alarm system, the present invention can monitor an area from a remote location and either activate a means for adjusting the area in danger of the damage, or, alternatively, communicate the danger to a repair person who is dispatched to the area for attention to such area.

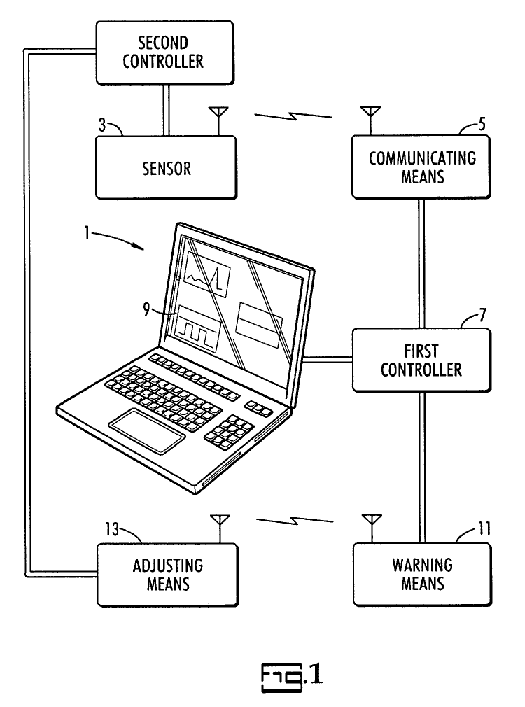

An example of an embodiment of the monitoring system 1 according to the present invention is illustrated in FIG. 1. As shown, the monitoring system includes a sensor 3. The sensor 3 can detect the humidity, moisture, or temperature of the environment in which it is placed. Additionally, the sensor 3 can detect a combination of humidity, moisture, and temperature. Also, the sensor 3 can include multiple sensors that can be connected or separated for measuring humidity, moisture content, and temperature, respectively.

Once humidity, temperature, and/or moisture is determined by the sensor 3, this information is transmitted to a first controller 7 by means for communicating 5. As discussed, the sensor 3 can include multiple sensors wherein each sensor specifically measures one of humidity, moisture content, and temperature. If these sensors are not connected, each sensor has the capability to transmit information to communicating means 5. The information can be transmitted in a number of ways, including electronically, by radio frequency through transmitters and receivers, and by wireless communication. Upon receiving the humidity, temperature, and/or moisture information, the first controller 7 processes the information, and can display it for monitoring, such as on a computer screen 9. The first controller 7 is programmed with a preset, desired humidity, temperature, and moisture content, so that when information is received by the first controller 7 that indicates the temperature, humidity, and/or moisture is above the preset, desired amount, the first controller 7 activates means for warning 11. In an embodiment, the first controller 7 can include a solid state relay. Next the warning means 11 communicates a need for an adjustment to the humidity, temperature, and/or moisture content to means for adjusting 13. Depending on whether the particular interior space being monitored includes capability for an automated adjusting means 13, the moisture, temperature, and/or humidity can be automatically adjusted to an amount approximately equal to or below the preset, desired humidity, temperature, and/or moisture. Alternatively, the warning means 11 can communicate the need for adjustment to a repair person who will be dispatched to the area in need of the adjustment.

The adjusting means 13 can also function independently of the monitoring system 1. As shown in FIG. 1, the adjusting means is connected to a second controller 20 that can also monitor the information obtained from the sensor 2 so as to optimize the ambient conditions of the interior space. In the event that the second controller 20 malfunctions, however, the first controller can initiate a warning signal through warning means 11 to adjusting means. Accordingly, the first controller 7 can serve as a back up to the second controller 20.

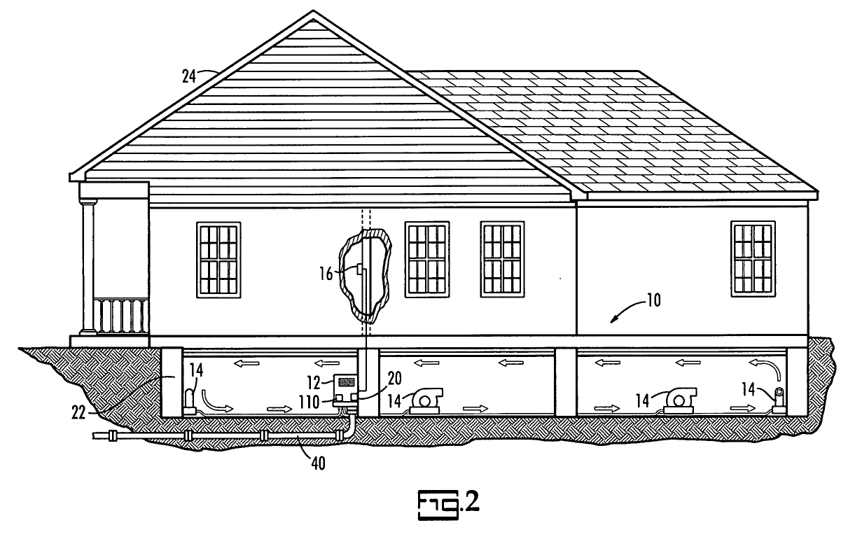

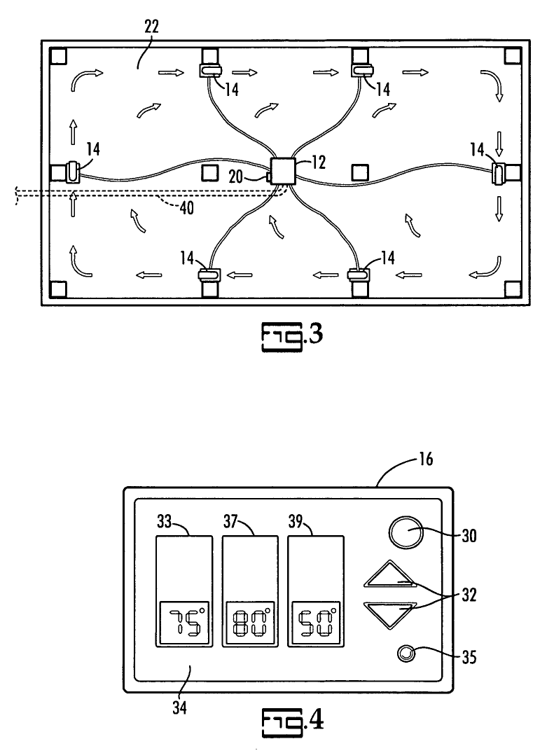

In an alternative embodiment, the adjusting means 13 includes a dehumidification system 10. As illustrated in FIGS. 2 and 3, the dehumidification system 10 includes a dehumidifier 12 that can be connected to a plurality of fans 14 and a user interface unit 16. The use of the fans 14, however, is optional. The dehumidification system 10 can be operated by a second controller 20 that can be included either within the vicinity dehumidifier 12 or the user interface unit 16. Alternatively, the dehumidification system 10 can be operated by the first controller 7 from a remote location. The warning means 11 of the monitoring system 1 can be connected to the second controller 20 so as to activate the dehumidification system 10 when there is a need to adjust the humidity, temperature, and/or moisture in the particular space being monitored. If the temperature needs adjustment, the adjustment means 13 can further be connected to an hvac unit, as discussed further below. The connection between the warning means 11 and the second controller 20 can be electronic, through radio frequency, or through wireless connection.

Although the dehumidification system 10 is shown to be located within a crawl space 22 or basement of a house 24, it is contemplated by the present invention that the dehumidification system 10 can be used within any area of the house 24, as well as other enclosed areas, such as storage sheds, RVs, boats, and 18-wheeler type vehicles.

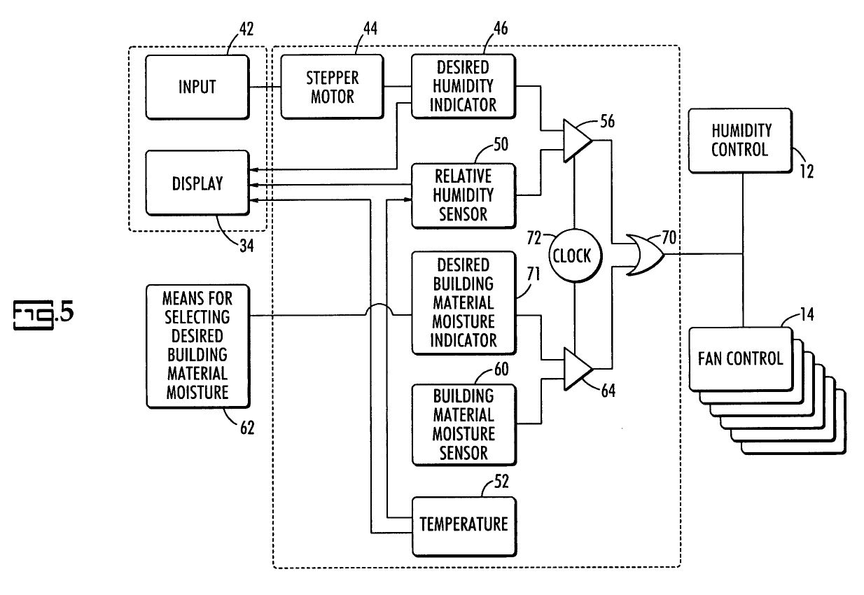

A feature of the present invention is the use of a dehumidification system 10 including the user interface 16, which can be used to operate the dehumidification system from remote locations. As illustrated in FIG. 4, the user interface 16 can be located within the main portion of the house 24 and be electrically wired, or have a wireless connection, to the dehumidifier 12 that is in the crawl space 22 of the house 24. Preferably, the user interface unit 16 includes a power input 30 for manually turning the system 10 on or off and a means for selecting a desired humidity 32 by which a user can incrementally adjust up and down the desired humidity of the area in which the dehumidifier 12 is located. The user interface unit 16 further includes a display 34 showing the current temperature and relative humidity of the area containing the dehumidifier, as well as the desired relative humidity, that has been set by the user. Finally, the user interface 16 can include a service light 35 that indicates when the system 10 needs maintenance or repair.

As shown, all the components of the dehumidification system 10 can be electrically wired and can obtain power by plugging the dehumidifier into a GFI (ground fault interrupter) outlet. Alternatively, the dehumidification system 10 can be operated by remote control, wherein a transmitting device capable of transmitting signals, such as radio or microwave, communicates with a receiver so as to turn the dehumidifier 12 on or off. Therefore, the system 10 can be completely automated through these connections.

The dehumidifier 12 can include any conventional arrangement. A typical dehumidifier removes moisture from the air by condensing the moisture from the air on its cooled evaporator coils. In the present invention, the condensed moisture can be collected in a retainer beneath the dehumidifier 12, and as shown in FIGS. 2 and 3, the condensation can drain into a pipe 40 that is routed to the exterior of the interior or enclosed space. Although a variety of dimensions are suitable for the dehumidifier 12 depending on the particular location needing to be dehumidified, the dehumidifier 12 is preferably less then 20 inches if the dehumidifier 12 is to go into the basement or crawl space of a house. Further, the dehumidifier 12 can be permanently installed next the wall of an interior space needing to be dehumidified.

A particular feature of the present invention is the use of an adjusting means 13 including the dehumidifier 12 in combination with the plurality of fans 14 that are advantageously positioned around the area needing to be dehumidified. Through the use of plural fans positioned in various locations around the dehumidifier 12, the moist air can be more effectively dried. Further, the fans contribute to the improvement of the environment of the interior space by circulating dried and fresh air. Preferably, the fans will pull less than or approximately 2 Amps of energy. However, more powerful fans are contemplated by the present invention.

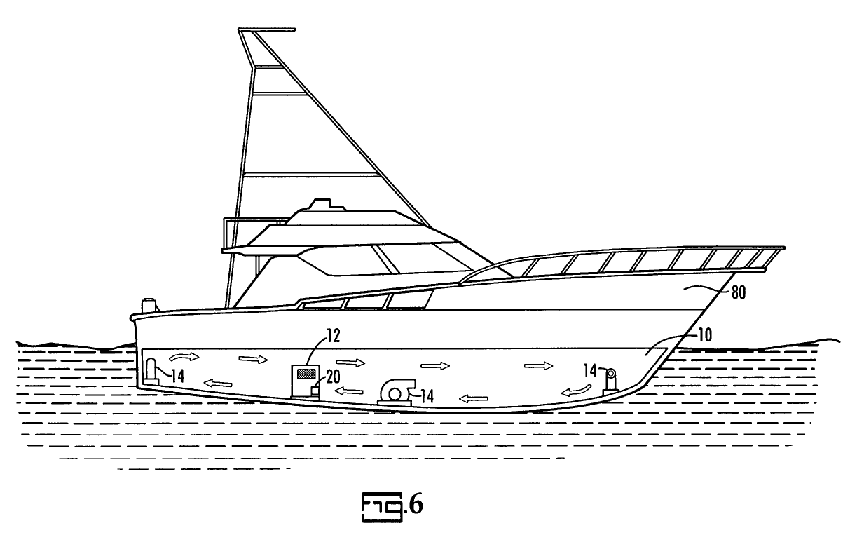

A schematic view of how the various components of the dehumidification system 10 operate is shown in FIG. 5. As illustrated, the user interface unit 16 includes an input section 42, including the power input 30 and the selecting means 32 (shown in FIG. 4), in which a user can program the desired humidity by increasing or decreasing the humidity displayed on display 34 (FIG. 4). The user changes the desired humidity using a stepper motor 44 that allows the desired humidity to be changed in increments by sending signals to a desired humidity indicator 46.

The programmed or pre-selected desired humidity is compared with the relative ambient humidity, which is measured by a humidity sensor 50. The humidity sensor 50 can use any instrument for measuring atmospheric humidity, such as a hygrometer, and a thermometer 52, because relative humidity is temperature sensitive. The humidity sensor 50 measures the actual humidity of the area in which the dehumidifier 12 has been placed. The relative humidity is also displayed on the user interface unit 16. In operation, the desired humidity and the actual humidity are compared by a first comparator 56. If the relative humidity is greater than desired humidity, then the dehumidifier 12 and the plurality of fans 14 are turned on, and if the relative humidity is less than the desired humidity 12, then the dehumidifier 12 and the plurality of fans 14 are turned off. Because the dehumidification system 10 is completely automated, a user need simply program a desired humidity and the system will thereafter operate itself to maintain this desired humidity. In an alternative embodiment, each fan of the plurality of fans 14 can include a relative humidity sensor and a desired humidity indicator so that the fans can turn on independently of the system 10 and prevent the entire system 10 failing in the case one of the fans malfunctions.

As previously discussed, the dehumidification system 10 can also include a building materials moisture sensor 60, such as a wood moisture sensor, that is used in combination with a humidity sensor 50. Although the system 10 need only contain one of these indicators, the use of a combination of indicators contributes to the prevention of moisture damage of the interior spaces containing the system 10. If the moisture content is too high in the building material of the interior space, dehumidifier 12 is started. However, if only the moisture content of the air is too high, rather than the building material, then the dehumidifier 12 will still be turned on. As with the humidity sensor 50, the actual building material moisture measured by the building material moisture sensor 60 is compared by a second comparator 64 to a pre-selected desired building material moisture, which is selected by a means for selecting a desired building material moisture 62, and depending on whether the actual building material moisture is higher or lower than the desired building material moisture, the dehumidifier 12 and the plurality of fans 14 are turned on or off. If the building material moisture sensor 60 and the humidity sensor 50 are used in combination, the system 10 preferably includes an “or” gate 70, wherein the information of the first comparator 56 and the information of the second comparator 64 is sampled by a clock 72 so that the dehumidifier 12 and the plurality of fans 14 will be turned on if either the humidity or the building material moisture require it.

The second controller 20 of the dehumidification system 10 can contain the sensor and indicator components, as illustrated in FIG. 5. However, it is also contemplated that the sensor and indicator components can be removed from the second controller 20 so that the controller need not remain in the vicinity of the dehumidifier 12. Furthermore, it is contemplated that the dehumidification system 10 can be controlled by the first controller 7 of the monitoring system 1.

The clock 72 of the dehumidification system 10, in addition to driving the repetition of comparisons of humidity and building moisture at short intervals, also indicates on the display 34 through the service light 35 a need for a maintenance or check up of the system 10 based on preset maintenance intervals. Further, the service light 35 can also indicate that the system 10 is somehow malfunctioning and needs to be repaired. The service light 35 is advantageous because it serves a warning to the user of the system 10. Therefore, the lifespan of the dehumidification system 10 can be prolonged, and its function enhanced.

As further illustrated in FIG. 5, the dehumidification system 10 can be connected to the monitoring system 1 through the warning means 11. Accordingly, the monitoring system can function similar to a burglar alarm system. Further, it is contemplated that each component of the dehumidification system 10 could be monitored by the monitoring system 1 so that if any one component or a combination of components malfunctioned, the warning means 11 could transmit such malfunction back to the first controller so as to initiate repair of the dehumidification system 10.

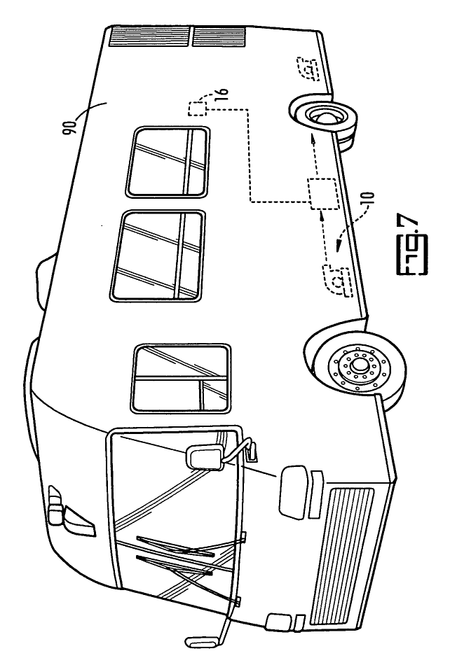

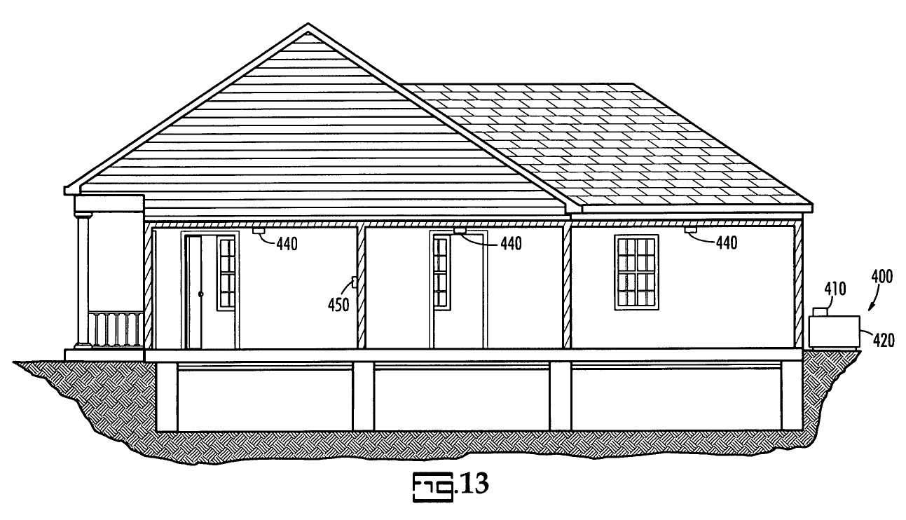

FIG. 6 represents the dehumidification system 10 of the present invention in use in a boat 80. In particular, the dehumidification system 10 can be used in the state rooms or the engine room of the boat 80. Another area to benefit from the use of the dehumidification system 10 is in an RV 90, as illustrated in FIG. 7. Both of these vehicles include many enclosed areas that may be susceptible to moisture damage. Although the system 10 in FIGS. 6 and 7 is shown to include the plurality of fans 14, it is contemplated that the system 10 would not be required in these areas, or other small areas. Yet another area that can benefit from the use of the dehumidification system 10 is in 18-wheeler and van-bodied equipped straight trucks. As shown in FIG. 12, an 18-wheeler truck 300 can include the dehumidification system 10 within the trailer 310 of the truck 300.

As discussed, a particular feature of the present invention is the use of a dehumidification system 10 in interior or enclosed spaces. Accordingly, any area that tends to become musty and mildewed is suitable for the dehumidification system 10. Not only will the use of a dehumidification system 10 in these areas reduce and prevent the musty odor caused by potential mildew, but also the materials used in these areas can be better preserved.

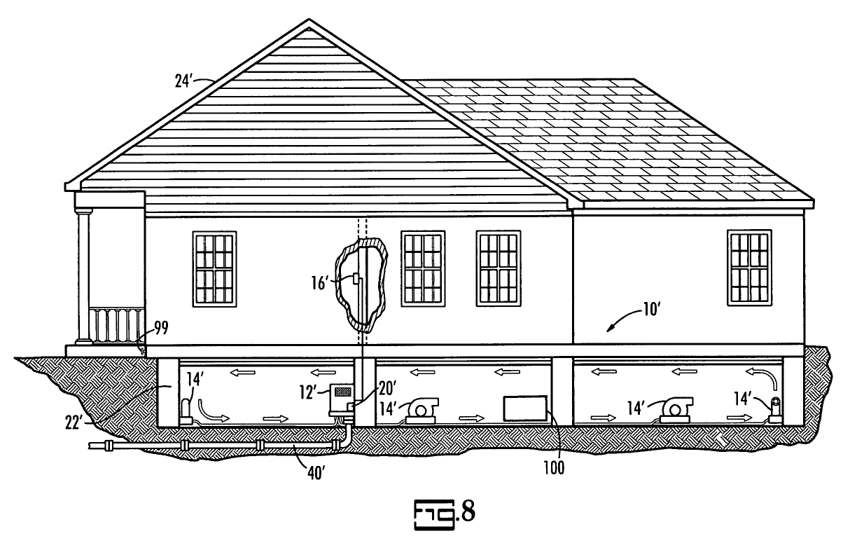

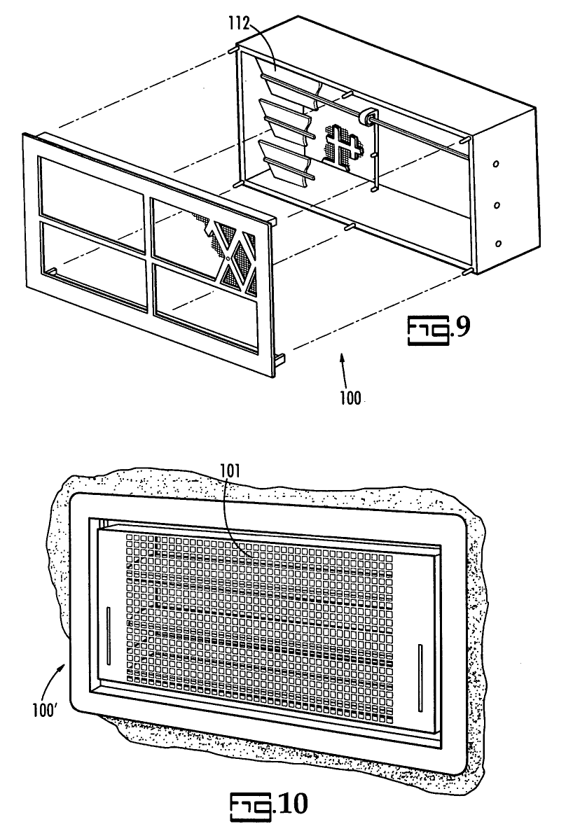

In an alternative embodiment, the adjusting means 13 includes a combination system having a ventilation system and a dehumidification system. An example of a ventilation system for combination with the dehumidification system 10′ of the present invention is described in detail in U.S. Pat. Nos. 4,208,010 and 4,328,927, which are incorporated herein by reference. The only modification to this ventilation system is that the louvers of the ventilator structure operate so that the louvers are open during cold weather and the louvers are closed during warm weather. Specifically, if the temperature is greater than approximately 60° F., the louvers will close. FIG. 8 illustrates the combination system. In particular, the dehumidification system 10′ for use in interior or enclosed spaces is shown in combination with a ventilation system 100. As illustrated in FIG. 8, the dehumidification system 10′ portion of the combination system includes a dehumidifier 12′ that can be connected to a plurality of fans 14′ and a user interface unit 16′. The system 10′ can be operated by a controller 20′ that can be included either within the vicinity dehumidifier 12′ or the user interface unit 16′. Alternatively, the dehumidification system 10′ can be operated by the first controller 7 of the monitoring system 1. Although the dehumidification system 10′ is shown to be located within a crawl space 22′ or basement of a house 24′, it is contemplated by the present invention that the dehumidification system 10′ can be used within any area of the house 24′, as well as other enclosed areas, such as storage sheds, RVs, 18-wheelers, and boats. FIG. 9 illustrates the ventilation system portion of the combination system in detail. As illustrated, the ventilation system 100 includes a housing 110 and multiple louvers 112 that operate in conjunction with the dehumidification system 10′.

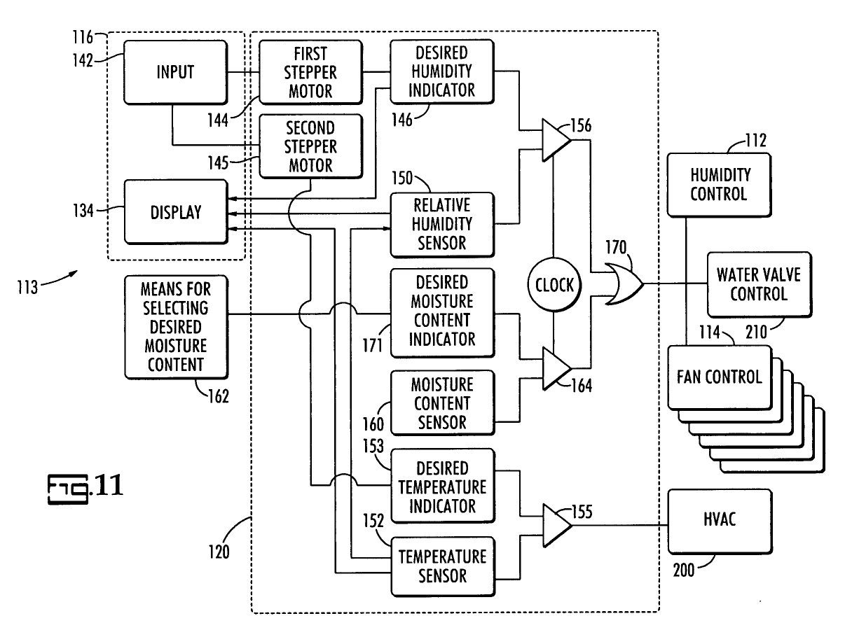

Alternatively, the ventilation system can include a ventilation device 100′, as shown in FIG. 10, and as described in U.S. Pat. No. 5,944,445. Depending on the temperature the vent 101 can open and close automatically. Preferably, the vent 101 remains closed at temperatures about 40° F. or below, and at temperatures about 60° F. and above.

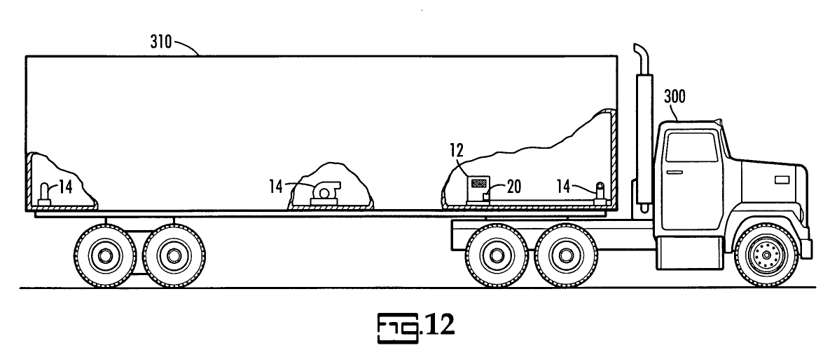

An alternative embodiment for the adjusting means 13 is illustrated in FIGS. 11 and 13. In particular, the adjusting means 13 can include an ambient adjustment system 113. The ambient adjustment system 113 can include a dehumidifier 410 and an hvac unit 420 that are both connected to sensors, which can be housed in sensor units 440, for determining humidity, moisture content, and temperature of the interior spaces being monitored for ambiance control. These sensors 440 can be in communication with either the first, remote controller 7 of the monitoring system 1 or with a second controller 120 that is in the vicinity of the ambient adjustment system 120. The second controller 120 can include a first sensor switch that turns the dehumidifier 410 on and off based on the ambient humidity and moisture content, and a second sensor switch that turns the hvac unit 420 on and off based on the temperature of the area in which the monitoring system 1 is placed. Additionally, the monitoring system 1 can include a user interface unit 116 that is separate or remote from the ambient adjustment system 113, and that can be used to operate the monitoring system 1 from various locations. Similar to the dehumidification system 10, this user interface 116 can include a number of inputs, as well as a service light, which indicates a need for maintenance or repair. The ambient adjustment system 113 can also be connected to a plurality of fans. Additionally, the ambient adjustment system 113 can further be connected to a vent system, such as described above. Further, the ambient adjustment system 113 can be connected to the main water valve of the structure being monitored so that the water can be shut off and on depending on the moisture content of the structure. It is further contemplated by the present invention that the features of the ambient adjustment system 116 can either be operated through standard electrical connections, through radio frequency, or through wireless connections.

A schematic view of how the various components of the ambient adjustment system 113 operate is shown in FIG. 11. As illustrated, the user interface unit 116 includes an input section 142, in which a user can program the desired humidity by increasing or decreasing the humidity displayed on display 134. The user can change the desired humidity using a first stepper motor 144 that allows the desired humidity to be changed in increments by sending signals to a desired humidity indicator 146. The desired temperature can also be programmed by using a second stepper motor 145.

The programmed or pre-selected desired humidity is compared with the relative ambient humidity, which is measured by a humidity sensor 150. The humidity sensor 150 can use any instrument for measuring atmospheric humidity, such as a hygrometer, and a temperature sensor 152, or thermometer, because relative humidity is temperature sensitive. The relative humidity can also displayed on the user interface unit 116. In operation, the desired humidity and the actual humidity are compared by a first comparator 156. If the relative humidity is greater than desired humidity, then the dehumidifier 410 is turned on through a humidity control 112, and can operate through the duct system of the particular structure similar to an hvac unit. If the relative humidity is less than the desired humidity 12, then the dehumidifier 410 is turned or kept off. Because the ambient adjustment system 113 is completely automated, a user need simply program a desired humidity and the system will thereafter operate itself to maintain this desired humidity. In an alternative embodiment, a plurality of fans can be employed in addition to the dehumidifier 410. The fans can be turned on and off through fan control 114 based on the ambient conditions. Alternatively, each fan of the plurality of fans can include a relative humidity sensor and a desired humidity indicator so that the fans can turn on independently of the ambient adjustment system 113 and prevent the entire system from failing in the case one of the fans malfunctions. Additionally, the ambient adjustment system 113 can be connected to the water valve of the structure being monitored, which can be turned on and off through a water valve control 210.

The ambient adjustment system 113 can also include a moisture content sensor 160, that can be used in combination with the humidity sensor 150. Although the adjustment system 113 need only contain one of these indicators, the use of a combination of indicators contributes to the prevention of moisture damage of the interior spaces being monitored. If the moisture content of the interior space is too high, the dehumidifier 410 is started. Alternatively, the dehumidifier 410 can be started in combination with a plurality of fans. Further, the water valve can be turned off. The ventilation system as described above can also be employed to lessen the potential moisture damage. As with the humidity sensor 150, the moisture content measured by the moisture content sensor 160 can be compared by a second comparator 164 to a pre-selected moisture content, which can be selected by a means for selecting a desired moisture content 162, and depending on whether the actual moisture content is higher or lower than the desired moisture content, the dehumidifier 410, the plurality of fans, and/or the water valve, can be turned on or off. If the moisture content sensor 160 and the humidity sensor 150 are used in combination, the ambient adjustment system 113 preferably includes an “or” gate 170, wherein the information of the first comparator 156 and the information of the second comparator 164 is sampled by a clock 172 so that the dehumidifier 410, the plurality of fans, and/or the water valve will be turned on if either the humidity or the moisture content require it.

As discussed, the ambient adjustment system 113 can include an hvac unit 200. A user of the system 113 can program a desired temperature through the use of the second stepper motor 145. The actual ambient temperature is measured through the temperature sensor 152. Similar to the humidity, the desired temperature shown on a desired temperature indicator 153 is compared to the actual temperature through the use of a third comparator 155. If the desired temperature is below the actual temperature the hvac unit 200 can be turned on.

The second controller 120 of the ambient adjustment system 113 can contain the sensor and indicator components, as illustrated in FIG. 11. However, it is also contemplated that the sensor and indicator components can be removed from the second controller 120 so that the controller need not remain in the vicinity of the dehumidifier 410. Furthermore, it is contemplated that the ambient adjustment system 113 can be controlled by the first controller 7 of the monitoring system 1.

The clock 172 of the ambient adjustment system 113, in addition to driving the repetition of comparisons of humidity and moisture content at short intervals, can also indicate on the display 134 through a service light (not shown) a need for a maintenance or check up of the adjustment system 113 based on an preset maintenance intervals. Further, the service light can also indicate that the system 113 is somehow malfunctioning and needs to be repaired. The service light is advantageous because it serves a warning to the user of the system 113. Therefore, the lifespan of the ambient adjustment system 113 can be prolonged, and its function enhanced.

As further illustrated in FIG. 11, the ambient adjustment system 113 can be connected to the monitoring system 1 through the warning means 11. Accordingly, the monitoring system can function similar to a burglar alarm system. Further, it is contemplated that each component of the ambient adjustment system 113 could be monitored by the monitoring system 1 so that if any one component or a combination of components malfunctioned, the warning means 11 could transmit such malfunction back to the first controller so as to initiate repair of the ambient adjustment system 113.

Finally, there are many alternative embodiments and modifications of the present invention that are intended to be included within the spirit and scope of the following claims.

1. A monitoring system, comprising:
a sensor for determining the actual humidity of an area;
a sensor for determining the actual moisture content of said area;
a sensor for determining the actual temperature of said area;
a first controller that is connected to said humidity sensor, said moisture content sensor, and said temperature sensor;
means for warning when the humidity, the moisture content, and the temperature within said area is above a preset, desired humidity, moisture content, and temperature, said warning means being connected to said first controller; and
means for adjusting the actual humidity, moisture content, and temperature to approximately equal to or below the preset, desired humidity, moisture content, and temperature, said adjusting means being connected to said warning means.

2. The monitoring system as recited in claim 1, wherein said adjusting means includes a dehumidification and hvac system, comprising:
a dehumidifier; and
an hvac unit, wherein said dehumidifier and said hvac unit are connected to said first controller, and wherein said first controller activates said dehumidifier when the actual humidity and/or moisture content is above the preset, desired humidity and/or moisture content, and wherein said first controller activates said hvac unit when the actual temperature is above the present, desired temperature.

3. The monitoring system as recited in claim 2, further comprising a plurality of fans that is connected to said first controller, and wherein said first controller activates said plurality of fans when the actual humidity and/or moisture content is above the preset, desired humidity and/or moisture content.

4. The monitoring system as recited in claim 2, further comprising a water valve connected to said area, wherein said first controller turns off said water valve when the actual moisture content is above the preset, desired moisture content.

5. The monitoring system as recited in claim 2, further comprising a ventilation system connected to said adjusting means.

6. The monitoring system as recited in claim 2, wherein said adjusting means includes a dispatched repair person.

7. The monitoring system as recited in claim 2, further comprising means for warning said first controller when said adjusting means has malfunctioned and is in need of maintenance.

8. The monitoring system as recited in claim 2, further comprising means for communicating the actual humidity, moisture content, and/or temperature to said first controller.

9. The monitoring system as recited in claim 8, wherein said humidity sensor, said moisture content sensor, said temperature sensor, said first controller, said communicating means, said warning means, and said adjusting means are electrically connected.

10. The monitoring system as recited in claim 8, wherein said humidity sensor, said moisture content sensor, said temperature sensor, said first controller, said communicating means, said warning means, and said adjusting means are connected by radio frequency communication.

11. The monitoring system as recited in claim 8, wherein said humidity sensor, said moisture content sensor, said temperature sensor, said first controller, said communicating means, said warning means, and said adjusting means are connected by wireless communication.

12. The monitoring system as recited in claim 2, further comprising a second controller that is connected to said dehumidifier and said hvac unit.

13. The monitoring system as recited in claim 1, wherein said adjusting means includes a dehumidification system, comprising:
a dehumidifier;
a user interface;
a humidity sensor for determining relative humidity of said area;
means carried by said user interface for selecting a desired humidity for said area; and
a second controller interconnected with said dehumidifier, said humidity sensor, and said selecting means, and wherein said controller activates said dehumidifier when said relative humidity is higher than said desired humidity.

14. The dehumidification system as recited in claim 13, wherein said dehumidifier, said user interface, and said second controller are connected by electrical wiring.

15. The dehumidification system as recited in claim 13, wherein said dehumidifier, said user interface, and said controller are connected by wireless connection.

16. The dehumidification system as recited in claim 13, further comprising a plurality of fans that are connected to said dehumidifier.

17. The dehumidification system as recited in claim 13, wherein said user interface unit includes a service light.

18. The dehumidifier as recited in claim 13, further comprising a building materials moisture sensor for measuring the actual building materials moisture in said area and means for selecting a desired building materials moisture, wherein said second controller activates said dehumidifier when the actual building materials moisture is higher than said desired building materials moisture.

18. The dehumidifier as recited in claim 13, wherein said second controller activates said dehumidifier either when said relative humidity is higher than said desired humidity or when said building materials moisture is higher than said desired building materials moisture.

19. An ambient adjustment means, comprising:
a sensor for determining the actual humidity of an area;
a sensor for determining the actual moisture content of said area;
a sensor for determining the actual temperature of said area;
a controller that is connected to said humidity sensor, said moisture content sensor, and said temperature sensor;
a dehumidifier; and
an hvac unit, wherein said dehumidifier and said hvac unit are connected to said controller, and wherein said controller activates said dehumidifier when the actual humidity and/or moisture content is above the preset, desired humidity and/or moisture content, and wherein said controller activates said hvac unit when the actual temperature is above the present, desired temperature.

20. The ambient adjustment system as recited in claim 19, further comprising a monitoring system that is connected to said controller, wherein said monitoring system includes a backup controller that will activate said dehumidifier and said hvac unit when said controller malfunctions.

21. A monitoring system, comprising:
a sensor for determining the actual humidity of an area;
a sensor for determining the actual moisture content of said area;
a sensor for determining the actual temperature of said area;
a first controller that is connected to said humidity sensor, said moisture content sensor, and said temperature sensor;
means for warning when the humidity, the moisture content, and the temperature within said area is above a preset, desired humidity, moisture content, and temperature, said warning means being connected to said first controller;
means for adjusting the actual humidity, moisture content, and temperature to approximately equal to or below the preset, desired humidity, moisture content, and temperature, said adjusting means being connected to said warning means; and
a second controller that is connected to said humidity sensor, said moisture content sensor, and said temperature sensor, wherein said second controller can operate said adjustment means independently of said first controller, and wherein said first controller activates said warning means when said second controller has malfunctioned.
